(19) United States
(12) Patent Application Publication
(10) Pub. No.: US 2017/0251875 A1
(43) Pub. Date: Sep. 7, 2017

(54) CONVECTION BARBEQUE COOKING APPARATUS

(71) Applicant: Douglas Kenneth Robinson, Philomath, OR (US)

(72) Inventor: Douglas Kenneth Robinson, Philomath, OR (US)

(21) Appl. No.: 15/390,631

(22) Filed: Dec. 26, 2016

Related U.S. Application Data
(60) Provisional application No. 62/389,665, filed on Mar. 7, 2016.

(51) Int. Cl. A47J 37/07

(52) U.S. Cl. CPC A47J 37/07; A47J 37/0786

(57) ABSTRACT

A convection barbeque cooking apparatus includes a hollow air column, a heating element, a cooking area, and one or more mesh screens. The hollow air column extends from a base section and includes air intake ports. The heating element is positioned inside the hollow air column, and above the air intake ports. The air suctioned through the air intake ports is heated and transferred upwardly through the hollow air column. The cooking area is positioned above and in fluid communication with the hollow air column, where the cooking area includes a cooking platform positioned proximal to a brim of the cooking area to place the food item to be cooked via convection barbeque. The mesh screens are positioned below the cooking platform to collect portions of the food item slipping from the cooking platform, and thereby preventing the portions from igniting due to contact with the heating element.

### CROSS-REFERENCE TO RELATED APPLICATION

This application claims the benefit of and priority to U.S. Provisional Application Ser. No. 62/389,665 entitled “Convection Cooking System” filed Mar. 7, 2016, the entirety of which is hereby incorporated by reference herein for all purposes.

### FIELD OF THE INVENTION

The present invention relates to a cooking device which uses a hot air convection method for cooking. More particularly, the present invention relates to a hot air driven cooking apparatus configured to use hot air convection to cook food, to reduce spilled food portions from falling on the heat source, and to reduce the chance of the food item from catching on fire.

### BACKGROUND

In conventional cooking systems, especially barbeque type systems, the heat source is positioned near the cooking platform. Such positioning allows the drippings from the food to drip onto the hot heat source causing flames, and in some cases causing the food to catch fire. This results in burnt food, unevenly cooked food, and bad tasting food. Furthermore, in a case where the heat source is directly exposed to wind, there are chances that the flames might be blown out, or result in uneven heating of the cooking platform over which the food is cooked.

In the case of cooking with gas barbeques, they have a metal heat deflector where the food drippings accumulate and catch fire, and the flames formed from such fire is transferred to the food. This problem arises because gas barbeques employ a radiant heat transfer mechanism to cook the food. In fact, most of the prior art devices use a radiant heat transfer mechanism to cook food on a cooking platform positioned in proximity with the heat source. Such an arrangement allows food drippings to accumulate and drip down on to the heat source. The food drippings are a flammable source of fire which are distinct from the main heat source of the barbeque. This can cause uneven heating, fire, and therefore irreparable damage to the barbeque equipment. This further leads to ignition and a transfer of flame from the accumulated drippings to the food itself. Any gas or charcoal grill that uses a metal plate to either protect the burner from drippings, or used to even the exhaust heat from the burners, is using radiant heat. Most prior art devices do not have a method to distribute the heat evenly, and instead they have uneven hot spots and cool spots even within separate control zones.

Hence, there is a long felt but unresolved need for an apparatus which works based on a heat convection barbeque method and independent of heat radiation. An apparatus which effectively prevents food drippings from accumulating or dropping on to the heat source, and shields the heat source from external winds which might extinguish the fire.

### SUMMARY OF THE INVENTION

The convection barbeque cooking apparatus disclosed herein works based on the usual heat convection method and is independent of heat radiation. The convection barbeque cooking apparatus effectively prevents food drippings from accumulating or dropping on to the heating element, and shields the heating element from external winds which might extinguish the fire. The convection barbeque cooking apparatus comprises a hollow air column, a heating element, a cooking area, and one or more mesh screens. The hollow air column extends from a base section, where the hollow air column comprises air intake ports to suction air from the atmosphere. The heating element is positioned inside the hollow air column, and above the air intake ports. The air suctioned through the air intake ports is heated and transferred upwardly through the hollow air column. The cooking area is positioned above and in fluid communication with the hollow air column to receive the heated air, where the cooking area comprises a cooking platform positioned proximal to a brim of the cooking area to place the food item to be cooked via convection from the heated air. The mesh screens are positioned below the cooking platform to collect portions of the food item slipping from the cooking platform, and thereby preventing the portions from igniting due to contact with the heating element.

In an embodiment, a predefined distance is provided between the heating element and the cooking platform to allow heated air proximal to the heating element to mix with the suctioned air through the air intake ports, thereby enabling heat exchange between the heated air and the suctioned air via heat convection. In an embodiment, the convection barbeque cooking apparatus further comprises a lid configured to close the cooking area, where the lid is configured to enable cooking under heat retention within an enclosed space defined by the closed lid and the cooking area.

In an embodiment, the air intake ports are positioned substantially at a bottom section of the hollow air column, where the air suctioning through the air intake ports is enabled through natural draft. In an embodiment, the convection barbeque cooking apparatus further comprises a second screen positioned inside the cooking area and below the mesh screen, wherein the second screen is configured to trap food or grease dropping from the food item, when the food item is cooked. In an embodiment, the heating source is a propane burner configured to be controlled by a control knob or a wood or charcoal heat source. In an embodiment, the convection barbeque cooking apparatus further comprises wheels attached on panels extending from the bottom section of the hollow air column, and the wheels allow displacement of the convection barbeque cooking apparatus.

In an embodiment, the hollow air column further comprises an inner column and an outer column coaxially aligned with each other. The heat generated from the heating element is contained inside the inner column, and space between the inner column and the outer column is heat insulated to be in a cool state. In an embodiment, the outer column further comprises the air intake ports, and the air intake ports are further configured to allow air to enter from outside to further cool down the space between the inner column and the outer column. In an embodiment, the convection barbeque cooking apparatus further comprises a plurality of heat deflectors positioned between the inner column and the cooking platform, where the heat deflectors facilitate even distribution of the heated air over the cooking platform to generate even cooking areas on the cooking platform. These heat deflectors can be engineered for any size or shape of cooking area, cooking grill, or cooking platform.

### BRIEF DESCRIPTION OF THE DRAWINGS

FIG. 1A exemplarily illustrates a front perspective schematic view of the convection barbeque cooking apparatus, showing the internal view of the convection barbeque cooking apparatus.

FIG. 1B exemplarily illustrates another front perspective view of an embodiment of the convection barbeque cooking apparatus.

FIG. 2 exemplarily illustrates an open bottom perspective view of the convection barbeque cooking apparatus.

FIG. 3 exemplarily illustrates top perspective view of a cooking platform of the convection barbeque cooking apparatus.

### DETAILED DESCRIPTION OF THE INVENTION

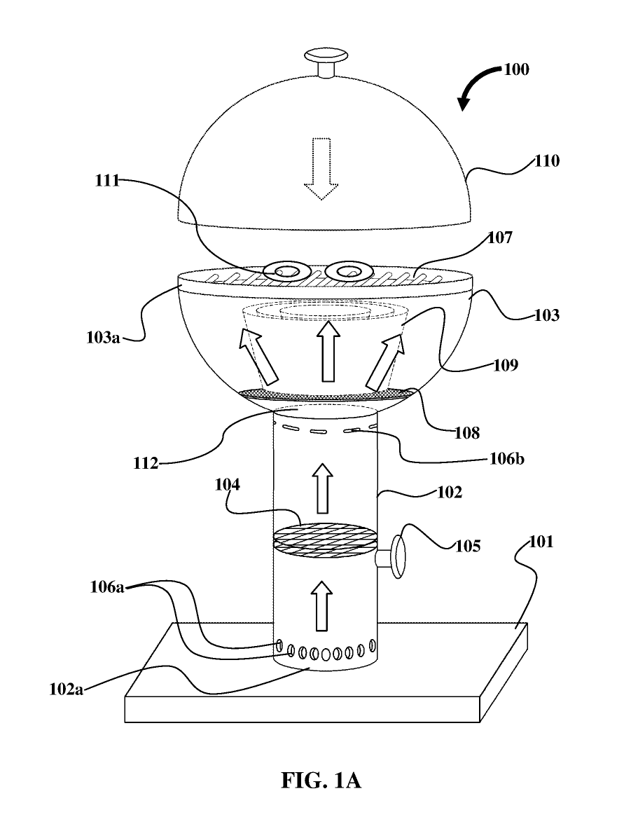

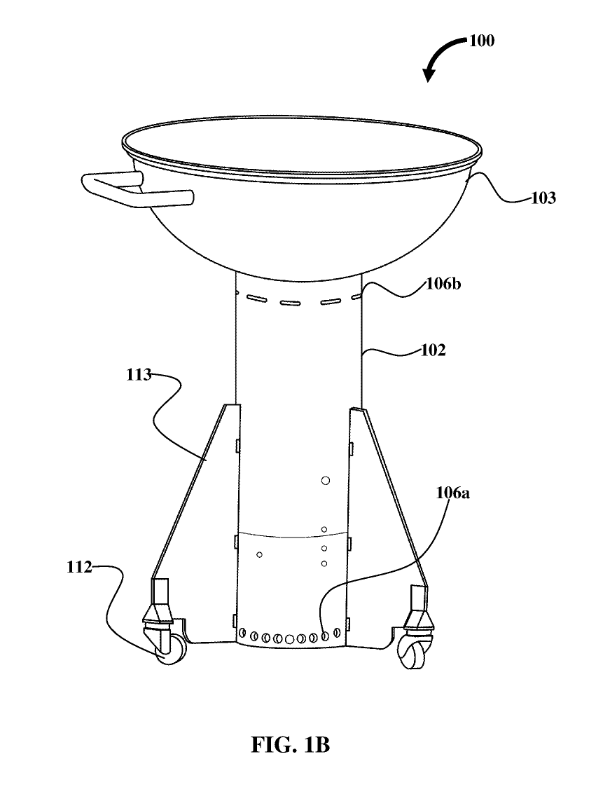

FIG. 1A exemplarily illustrates a front perspective view of the convection barbeque cooking apparatus 100, showing the internal view of the convection barbeque cooking apparatus 100. The convection barbeque cooking apparatus 100 comprises a hollow air column 102, a heating element 104, a cooking area 103, and a mesh screen 108. The hollow air column 102 extends from a base section 101, where the hollow air column 102 comprises air intake ports 106a to suction air from atmosphere, as shown by the arrows in FIG. 1A. Atmospheric air is suctioned either via natural draft or forced draft as explained further in the description. The heating element 104 is positioned inside the hollow air column 102, and above the air intake ports 106a. Since the convection barbeque cooking apparatus 100 finds most of its application for outdoor cooking purposes, such as, grilled foods using barbeque, the heating element 104 located inside the hollow air column 102 is inherently wind resistant and has a much less probability to blow out.

As shown by the arrows inside the hollow air column 102, the air suctioned through the air intake ports 106a is heated and transferred upwardly through the hollow air column 102. In other words, the process of suctioning the air can also be termed as an air induction system which allows the air to enter the hollow air column 102 from below the heating element 104. The cooking area 103 has an opening 112 at its bottom, and the cooking area 103 is positioned above, and in fluid communication with the hollow air column 102 to receive the heated air. The cooking area 103 comprises a cooking platform 107 positioned proximal to a brim 103a of the cooking area 103 to place and cook the food item 111 via convection from the heated air. The convection heat is used as the primary cooking medium. This also helps in preventing the food item 111 from catching fire by avoiding the radiant heat from a steel plate that may cover the heating element 104 from being transferred to the food item 111. Convection heat also cooks the food item 111 without a “warm up” period and enables overall faster cooking times.

However, while the food item 111 is cooked, there are chances that portions of the food item 111 may drip down onto the heating element 104, for example, during an outdoor barbeque, which may damage the heating element 104 or may cause a fire eruption. Therefore, a mesh screen 108 is introduced to prevent this problem. The mesh screen 108 is positioned below the cooking platform 107 to collect portions of the food item 111 slipping from the cooking platform 107, and thereby preventing the portions from igniting due to contact with the heating element 104.

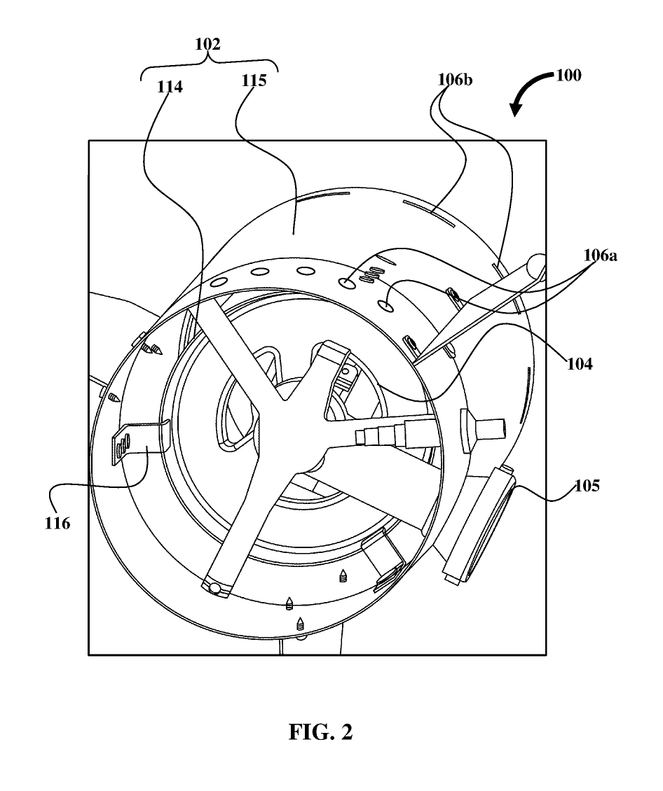

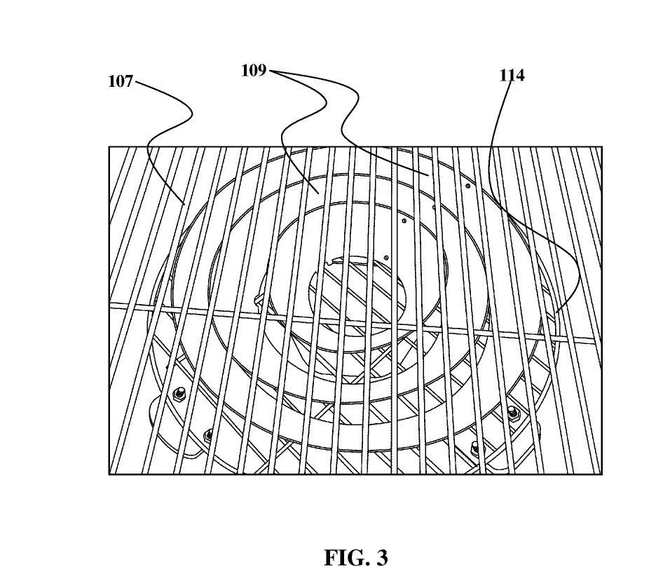

The mesh screen 108 breaks up or atomizes the drippings from the food item 111, and accelerate evaporation, that is, a drip atomizing system where most food drippings break into small droplets and combust in the heated hollow air column 102, and impart smoky flavor to the food item 111 without damaging the heating element 104. Therefore, the mesh screen 108 is used to atomize the drippings as they fall into the inner column 114, as described in FIG. 2, further aids in the combustion of the drippings adding smoky flavor to the food item 111, allows heat to pass easily through the screens or mesh screen 108, and allows the food drippings to be stopped and burned up in the hot air. The heat deflectors 109 positioned over the mesh screen 108 for even heat distribution is described further in FIG. 3.

Considering the conventional cooking devices, if the heating element 104 is positioned close to the cooking platform 107, then there is a high probability that the un-evaporated liquid food drippings might immediately fall on the heating element 104 and damage the heating element 104. Further, in the case of convection heat transfer, a small gap between the heating element 104 and the cooking platform 107 is not enough to establish a proper heat transfer between the heated air and the suctioned air. Therefore, in the convection barbeque cooking apparatus 100, a predefined separation distance is provided between the heating element 104 and the cooking platform 107. The predefined distance between the heating element 104 and the cooking platform 107 also avoids the food item 111 from being ignited due to food drippings falling in close proximity of the heating element 104.

The predefined distance allows heated air proximal to the heating element 104 to mix with the suctioned air through the air intake ports 106a, and a part of the heated suctioned air is vented through a set of air outlet ports 106b, thereby enabling heat exchange between the heated air and the suctioned air via convection. The distance enables thorough mixing of the heated air and suctioned air to establish an optimum heat exchange via heat convection. Furthermore, the heat is transferred without any radiant heat transfer, since the radiant heat transfer may not provide uniform heat distribution as compared to the convection barbeque heat transfer.

In an embodiment, the convection barbeque cooking apparatus 100 further comprises a lid 110 configured to close the cooking area 103, where the lid 110 is configured to enable cooking under heat retention within an enclosed space defined by the closed lid 110 and the cooking area 103. The lid 110 area, enables the convection barbeque cooking apparatus 100 to retain heat within the cooking area 103. In an example, the lid 110 might also comprise a heat reflective inner lining to allow the head generated in the cooking area 103 to be further contained within the cooking area 103. In an embodiment, the air intake ports 106a are positioned substantially at a bottom section 102a of the hollow air column 102, where the air suctioning through the air intake ports 106a is enabled through natural draft. The ‘natural draft’ is referred to the process of air being suctioned into a tube from below, owing to the difference in air densities inside and outside the hollow column. In an embodiment, the heating element 104 is a propane gas burner configured to be controlled by a control knob 105.

In other words, the convection barbeque cooking apparatus 100 separates the heating element 104 from the cooking platform 107 holding the food item 111 by a considerable distance. The heating element 104 generates a column of hot air that mixes with the suctioned air to cook the food item 111 by convection of the heated air. The separation of the heating element 104, the cooking platform 107, and the column of rising hot air, prevents liquid drippings from the food item 111 from falling over the heating element 104. In addition, by adjusting the position of the cooking platform 107 within the cooking area 103, a user can cook the food item at different convection cooking temperature zones. In most cases, the drippings evaporate within the hollow air column 102 due to the upward movement of the fast-moving hot air in the hollow air column 102. This results in a more even cooking of the food item 111, a marked reduction in flames caused by the ignition of the drippings, and a better tasting food.

FIG. 1B exemplarily illustrates another front perspective view of an embodiment of the convection barbeque cooking apparatus 100. This embodiment comprises wheels 112 attached on panels 113 extending from the bottom section of the hollow air column 102, where the wheels 112 allow displacement of the convection barbeque cooking apparatus 100. The wheels 112 are, for example, caster wheels which are hinged below the panels 113 to move the convection barbeque cooking apparatus 100. The air intake ports 106a are positioned at an lower section of the hollow air column 115 as further discussed in FIG. 1A and FIG. 2.

FIG. 2 exemplarily illustrates an open bottom perspective view of the convection barbeque cooking apparatus 100, showing the view from a bottom to the top of the inner column 114 and outer column 115, and the burner assembly or heating element 104. In an embodiment, the hollow air column 102 further comprises an inner column 114 and an outer column 115 coaxially aligned with each other. The inner column 114 and the outer column 115 are fastened to each other via flanged joints 116. The heat generated from the heating element 104 is contained inside the inner column 114, and space between the inner column 114 and the outer column 115 is heat insulated to be in a cool state. The inner column 114 is a heat reflective surface which increases the convective heat within the inner column 114 and prevents the heat to radiate into the space between the inner column 114 and the outer column 115.

In an embodiment, the outer column 115 comprises the air intake ports 106a configured to allow air to enter from outside, flow through the outer column 115 and exit through the air outlet ports 106b to further cool down the space between the inner column 114 and the outer column 115. This allows the outside surface of the outer column 115 to be in a cooler condition, and thereby adds to the safety of the convection barbeque cooking apparatus 100. The use of the burner or heating element 104 inside an outer column 115 that has controlled or engineered air intake ports 106a makes the whole system much less susceptible to the heat source or heating element 104 being blown out by wind.

FIG. 3 exemplarily illustrates top perspective view of the cooking platform 107 of the convection barbeque cooking apparatus 100. In an embodiment, the convection barbeque cooking apparatus 100 further comprises a plurality of heat deflectors 109 positioned between the inner column 114 and the cooking platform 107, and the heat deflectors 109 facilitate even distribution of the heated air over the cooking platform 107 to generate even cooking areas on the cooking platform 107. That is, the physical heat deflectors 109 are seated below the grilling surface or the cooking platform 107, and above the inner column 114, that divides the hot air into more repeatable and even cooking areas based on the distance from the center of the inner column 114. The use of a non-closing vent on the grill cover or cooking platform 107 better aids in the convection air flow and tailor the flow of hot air to a particular spot on the grill surface to better cook thick food items 111.

Therefore, the convection barbeque cooking apparatus 100 provides a savings in propane usage to about 20% less with the same amount of cooked food item 111, and further there is much less cleaning than charcoal or normal gas grills. In fact, if a user turns the heat of the convection barbeque cooking apparatus 100 for several minutes, then the convection barbeque cooking apparatus 100 will self-clean due to the heated air. Further, the convection barbeque cooking apparatus 100 facilitates a uniform heat distribution system with the convection heat transfer process, establishes repeatable heat control zones within the cooking area 103, and defines an efficient dual coaxial heat column defined by the heating element 104 and the heated hollow air column 102. In other words, the convection barbeque cooking apparatus 100 distributes the rising column of heated air into distinct zones for repeatable and controlled cooking.

The foregoing examples have been provided merely for the purpose of explanation and are in no way to be construed as limiting of the present concept disclosed herein. While the concept has been described with reference to various embodiments, it is understood that the words, which have been used herein, are words of description and illustration, rather than words of limitation. Further, although the concept has been described herein with reference to particular means, materials, and embodiments, the concept is not intended to be limited to the particulars disclosed herein; rather, the concept extends to all functionally equivalent structures, methods and uses, such as are within the scope of the appended claims. Those skilled in the art, having the benefit of the teachings of this specification, may affect numerous modifications thereto and changes may be made without departing from the scope and spirit of the concept in its aspects.

I claim:

1. A convection barbeque cooking apparatus comprising;
a hollow air column extending from a base section, wherein the hollow air column comprises air intake ports to suction air from atmosphere;
a heating element positioned inside the hollow air column, above the air intake ports, wherein the air suctioned through the air intake ports is heated and transferred upwardly through the hollow air column;
a cooking area positioned above and in fluid communication with the hollow air column to receive the heated air, wherein the cooking area comprises a cooking platform positioned proximal to a brim of the cooking area to place the food item to be cooked via convection from the heated air; and
one or more mesh screens positioned below the cooking platform to collect portions of the food item slipping from the cooking platform, and thereby preventing the portions from igniting due to contact with the heating element.

2. The convection barbeque cooking apparatus of claim 1, wherein a predefined distance is provided between the heating element and the cooking platform to allow heated air proximal to the heating element to mix with the suctioned air through the air intake ports, thereby enabling heat exchange between the heated air and the suctioned air via heat convection.

3. The convection barbeque cooking apparatus of claim 2, wherein the predefined distance between the heating element and the cooking platform avoids the food item from being ignited due to food drippings falling in close proximity to the heating element.

4. The convection barbeque cooking apparatus of claim 1, further comprising a lid configured to close the cooking area, wherein the lid is configured to enable cooking under heat retention within an enclosed space defined by the closed lid and the cooking area.

5. The convection barbeque cooking apparatus of claim 1, wherein the air intake ports are positioned substantially at a bottom section of the hollow air column, wherein the air suctioning through the air intake ports is enabled through natural draft.

6. The convection barbeque cooking apparatus of claim 1, further comprising a second screen positioned inside the cooking area and below the mesh screen, wherein the second screen is configured to trap smoke particles dropping from the food item, when the food item is cooked via smoking process.

7. The convection barbeque cooking apparatus of claim 1, wherein the heating element is a propane gas burner configured to be controlled by a control knob.

8. The convection barbeque cooking apparatus of claim 1, further comprising wheels attached on panels extending from the bottom section of the hollow air column, wherein the wheels allow displacement of the convection barbeque cooking apparatus.

9. The convection barbeque cooking apparatus of claim 1, wherein the hollow air column further comprises an inner column and an outer column coaxially aligned with each other, wherein the heat generated from the heating element is contained inside the inner column, and space between the inner column and the outer column is heat insulated to be in a cool state.

10. The convection barbeque cooking apparatus of claim 9, wherein the outer column further comprises the air intake ports, wherein the air intake ports are further configured to allow air to entire from outside to further cool down the space between the inner column and the outer column.

11. The convection barbeque cooking apparatus of claim 9, further comprising a plurality of heat deflectors positioned between the inner column and the cooking platform, wherein the heat deflectors facilitate even distribution of the heated air over the cooking platform to generate even cooking areas on the cooking platform.
